(19) United States
(12) Patent Application Publication
(10) Pub. No.: US 2016/0139945 A1
(43) Pub. Date: May 19, 2016

(54) TECHNIQUES FOR CONSTRUCTING VIRTUAL IMAGES FOR INTERDEPENDENT APPLICATIONS

(71) Applicant: INTERNATIONAL BUSINESS MACHINES CORPORATION, ARMONK, NY (US)

(72) Inventors: JOHN A. GRIFFITH, AUSTIN, TX (US); JOSEPH P. LOEWENGRUBER, RALEIGH, NC (US); DANIEL RHAMES, AUSTIN, TX (US); PHILIP R. RIEDEL, CARY, NC (US); SANDRA TIPTON, AUSTIN, TX (US)

(73) Assignee: INTERNATIONAL BUSINESS MACHINES CORPORATION, ARMONK, NY (US)

(21) Appl. No.: 14/543,299

(22) Filed: Nov. 17, 2014

(51) Int. Cl. G06F 9/455; G06F 3/06; G06F 9/50; H04L 29/08

(52) U.S. Cl. CPC G06F 9/45558; H04L 67/10; G06F 3/065; G06F 3/0641; G06F 3/0619; G06F 3/067; G06F 9/5055; G06F 2009/45562

(57) ABSTRACT

A technique for automating the construction of multiple virtual images with interdependencies includes creating a first virtual image (VI) instance by extending a first base VI based on input values associated with the first base VI and software bundles associated with the first base VI. A second VI instance is created by extending a second base VI based on input values associated with the second base VI, instance values received from the first VI instance, dependency instance values received from a deployed dependency instance, and software bundles associated with the second base VI. The first and second VI instances are then deployed to designated machines in a cloud environment for execution.

### BACKGROUND

The present disclosure is generally directed to techniques for constructing virtual images and, more specifically, to techniques for constructing virtual images for interdependent applications.

In general, cloud computing refers to Internet-based computing where shared resources, software, and information are provided to users of computer systems and other electronic devices (e.g., mobile phones) on demand, similar to the electricity grid. Adoption of cloud computing has been aided by the widespread utilization of virtualization, which is the creation of a virtual (rather than actual) version of something, e.g., an operating system, a server, a storage device, network resources, etc. A virtual machine (VM) is a software implementation of a physical machine (PM), e.g., a computer system (data processing system), that executes instructions like a PM. VMs are usually categorized as system VMs or process VMs. A system VM provides a complete system platform that supports the execution of a complete operating system (OS). In contrast, a process VM is usually designed to run a single program and support a single process. A VM characteristic is that application software running on the VM is limited to the resources and abstractions provided by the VM. System VMs (also referred to as hardware VMs) allow the sharing of the underlying PM resources between different VMs, each of which executes its own OS. The software that provides the virtualization and controls the VMs is typically referred to as a VM monitor (VMM) or hypervisor. A hypervisor may run on bare hardware (Type 1 or native VMM) or on top of an operating system (Type 2 or hosted VMM).

Cloud computing provides a consumption and delivery model for information technology (IT) services based on the Internet and involves over-the-Internet provisioning of dynamically scalable and usually virtualized resources. Cloud computing is facilitated by ease-of-access to remote computing websites (e.g., via the Internet or a private corporate network) and frequently takes the form of web-based tools or applications that a cloud consumer can access and use through a web browser, as if the tools or applications were a local program installed on a computer system of the cloud consumer. Commercial cloud implementations are generally expected to meet quality of service (QoS) requirements of consumers and typically include service level agreements (SLAs). Cloud consumers avoid capital expenditures by renting usage from a cloud vendor (i.e., a third-party provider). In a typical cloud implementation, cloud consumers consume resources as a service and pay only for resources used.

IBM® Rational Team Concert (RTC)™ is a software development team collaboration tool that is available in both a client version and a web version. The RTC tool provides a collaborative environment that software development teams may use to manage all aspects of their work, e.g., plans, tasks, revision control, build management, and reports. IBM Tivoli® Netcool®/OIVNIbu5™ software delivers near real-time, consolidated event management across business infrastructure, data centers, complex networks, and information technology (IT) domains. The Netcool/OMNIbus software provides full management and automation to facilitate delivery of continuous uptime of business services and applications. IBM SmartCloud Orchestrator (SCO)™ provides cloud management for IT services. SCO is based on open standards and can manage public, private, and hybrid clouds through an easy-to-use interface. SCO provides access to ready-to-use patterns and content packs, which helps to speed configuration, provisioning, and deployment. SCO integrates metering, usage, accounting, monitoring, and capacity management of cloud services.

IBM Tivoli Business Service Manager (TBSM)™ is configured to monitor business services and track the business services against business objectives and technology infrastructure. TBSM provides the operational status of services using prebuilt reports, scorecards, and dashboards for fast data analysis. TBSM facilitates assessing service levels throughout an organization for more effective service management. TBSM delivers real-time information that may be required in order to respond to alerts to be in line with business requirements, and optionally to meet service-level agreements (SLAs). TBSM tools facilitate building a service model that may be integrated with Netcool/OMNIbus alerts or optionally with data from a software query language (SQL) data source. The TBSM data server analyzes Netcool/OMNIbus ObjectServer events or SQL data for matches against incoming status rules that are configured for a service model. If the matching data changes the service status, the status of the TBSM service model changes accordingly.

When a services status changes, TBSM sends corresponding service events back to the ObjectServer. The TBSM console provides a graphical user interface (GUI) and may run in the Tivoli Integrated Portal (TIP) and logically link services and business requirements within a service model, which provides an operator with a view of how an enterprise performs at a certain moment in time or did perform over a certain time period. The TBSM dashboard server manages the display of the TBSM console and communicates with the TBSM data server. This interaction between the different TBSM components facilitates creation and visualization of service models using connected TBSM consoles. The TBSM dashboard server acquires and maintains status of services from the TBSM data server. The TBSM data server monitors the ObjectServer and external databases for data that affect the status of the services that may be configured in the TBSM console. The TBSM dashboard server calculates the status of these services by applying rules to the external data, based on service models and rules that are stored in the TBSM database.

The IBM Image Construction and Composition (ICON)™ tool facilitates building virtual images (VIs) for deployment into cloud environments. ICON implements a model-driven design approach that generally makes creating and deploying VIs easier. The ICON tool facilitates building reusable VI assets that can be deployed into, for example, VMware ESX™ and PowerVM™ clouds. ICON is designed to facilitate a separation of concern and tasks, where experts build software bundles for reuse by others. In general, the design approach implemented by ICON simplifies the complexity of VI creation and reduces errors.

### BRIEF SUMMARY

Disclosed are a method, a data processing system, and a computer program product (embodied in a computer-readable storage device) for constructing virtual images for interdependent applications.

A technique for automating the construction of multiple virtual images with interdependencies includes creating a first virtual image (VI) instance by extending a first base VI based on input values associated with the first base VI and software bundles associated with the first base VI. A second VI instance is created by extending a second base VI based on input values associated with the second base VI, instance values received from the first VI instance, dependency instance values received from a deployed dependency instance, and software bundles associated with the second base VI. The first and second VI instances are then deployed to designated virtual machines in a cloud environment for execution.

The above summary contains simplifications, generalizations and omissions of detail and is not intended as a comprehensive description of the claimed subject matter but, rather, is intended to provide a brief overview of some of the functionality associated therewith. Other systems, methods, functionality, features and advantages of the claimed subject matter will be or will become apparent to one with skill in the art upon examination of the following figures and detailed written description.

The above as well as additional objectives, features, and advantages of the present invention will become apparent in the following detailed written description.

### BRIEF DESCRIPTION OF THE DRAWINGS

The description of the illustrative embodiments is to be read in conjunction with the accompanying drawings, wherein:

FIG. 1 depicts a relevant portion of an exemplary cloud computing node that is configured according to an embodiment of the present disclosure;

FIG. 2 depicts a relevant portion of an exemplary cloud computing environment that is configured according to an embodiment of the present disclosure;

FIG. 3 depicts exemplary abstraction model layers of a cloud computing environment configured according to an embodiment of the present disclosure;

FIG. 4 depicts an exemplary generic system for building virtual images (VIs) with interdependencies, according to an embodiment of the present disclosure;

FIG. 5 depicts an exemplary specific system for building VIs with interdependencies, according to one embodiment of the present disclosure;

FIG. 6 is a flowchart of an exemplary process for building VIs with interdependencies, according to an embodiment of the present disclosure;

FIG. 7 is a flowchart depicting a portion of the exemplary process for building VIs with interdependencies of FIG. 6 with additional detail for certain blocks, according to an embodiment of the present disclosure;

FIG. 8 depicts an exemplary specific system for integrating virtual images (VIs) in a cloud deployment pattern, according to one embodiment of the present disclosure; and

FIG. 9 is a flowchart of an exemplary process for integrating VIs in a cloud deployment pattern, according to an embodiment of the present disclosure.

### DETAILED DESCRIPTION

The illustrative embodiments provide a method, a data processing system, and a computer program product (embodied in a computer-readable storage device) for constructing virtual images for interdependent applications.

In the following detailed description of exemplary embodiments of the invention, specific exemplary embodiments in which the invention may be practiced are described in sufficient detail to enable those skilled in the art to practice the invention, and it is to be understood that other embodiments may be utilized and that logical, architectural, programmatic, mechanical, electrical and other changes may be made without departing from the spirit or scope of the present invention. The following detailed description is, therefore, not to be taken in a limiting sense, and the scope of the present invention is defined by the appended claims and equivalents thereof.

It is understood that the use of specific component, device and/or parameter names are for example only and not meant to imply any limitations on the invention. The invention may thus be implemented with different nomenclature/terminology utilized to describe the components/devices/parameters herein, without limitation. Each term utilized herein is to be given its broadest interpretation given the context in which that term is utilized. As may be utilized herein, the term ‘coupled’ encompasses a direct electrical connection between components or devices and an indirect electrical connection between components or devices achieved using one or more intervening components or devices.

It should be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed. Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. A cloud model may include at least five characteristics, at least three service models, and at least four deployment models.

Cloud characteristics may include: on-demand self-service; broad network access; resource pooling; rapid elasticity; and measured service. Cloud service models may include: software as a service (SaaS); platform as a service (PaaS); and infrastructure as a service (IaaS). Cloud deployment models may include: private cloud; community cloud; public cloud; and hybrid cloud.

On-demand self-service means a cloud consumer can unilaterally provision computing capabilities, such as server time and network storage, as needed automatically without requiring human interaction with a service provider. Broad network access means capabilities are available over a network and accessed through standard mechanisms that promote use by heterogeneous thin or thick client platforms (e.g., mobile phones, laptops, and personal digital assistants (PDAs)). Resource pooling means computing resources of a provider are pooled to serve multiple consumers using a multi-tenant model, with different physical and virtual resources dynamically assigned and reassigned according to demand. In resource pooling there is a sense of location independence in that the consumer generally has no control or knowledge over the exact location of the provided resources but may be able to specify location at a higher level of abstraction (e.g., country, state, or datacenter).

Rapid elasticity means capabilities can be rapidly and elastically provisioned, in some cases automatically, to quickly scale-out and be rapidly released to quickly scale-in. To the consumer, the capabilities available for provisioning often appear to be unlimited and can be purchased in any quantity at any time. Measured service means cloud systems automatically control and optimize resource use by leveraging a metering capability at some level of abstraction that is appropriate to the type of service (e.g., storage, processing, bandwidth, and active user accounts). Resource usage can be monitored, controlled, and reported providing transparency for both the provider and consumer of the utilized service.

In an SaaS model the capability provided to the consumer is to use applications of a provider that are running on a cloud infrastructure. The applications are accessible from various client devices through a thin client interface such as a web browser (e.g., web-based e-mail). In the SaaS model, the consumer does not manage or control the underlying cloud infrastructure (including networks, servers, operating systems, storage, or even individual application capabilities), with the possible exception of limited user-specific application configuration settings.

In a PaaS model a cloud consumer can deploy consumer-created or acquired applications (created using programming languages and tools supported by the provider) onto the cloud infrastructure. In the PaaS model, the consumer does not manage or control the underlying cloud infrastructure (including networks, servers, operating systems, or storage), but has control over deployed applications and possibly application hosting environment configurations.

In an IaaS service model a cloud consumer can provision processing, storage, networks, and other fundamental computing resources where the consumer is able to deploy and run arbitrary software (which can include operating systems and applications). In the IaaS model, the consumer does not manage or control the underlying cloud infrastructure but has control over operating systems, storage, deployed applications, and possibly limited control of select networking components (e.g., host firewalls).

In a private cloud deployment model the cloud infrastructure is operated solely for an organization. The cloud infrastructure may be managed by the organization or a third party and may exist on-premises or off-premises. In a community cloud deployment model the cloud infrastructure is shared by several organizations and supports a specific community that has shared concerns (e.g., mission, security requirements, policy, and compliance considerations). The cloud infrastructure may be managed by the organizations or a third party and may exist on-premises or off-premises. In a public cloud deployment model the cloud infrastructure is made available to the general public or a large industry group and is owned by an organization selling cloud services.

In a hybrid cloud deployment model the cloud infrastructure is a composition of two or more clouds (private, community, or public) that remain unique entities but are bound together by standardized or proprietary technology that enables data and application portability (e.g., cloud bursting for load-balancing between clouds). In general, a cloud computing environment is service oriented with a focus on statelessness, low coupling, modularity, and semantic interoperability. At the heart of cloud computing is an infrastructure that includes a network of interconnected nodes.

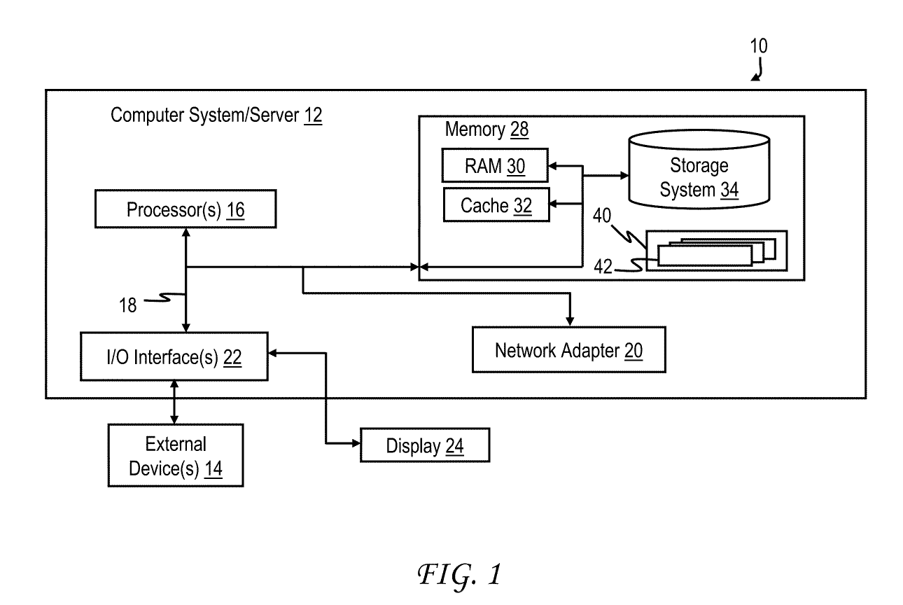

With reference to FIG. 1, a schematic of an exemplary cloud computing node 10 is shown. Cloud computing node 10 is only one example of a suitable cloud computing node and is not intended to suggest any limitation as to the scope of use or functionality of embodiments described herein. Regardless, cloud computing node 10 is capable of being implemented and/or performing any of the functionality set forth herein. Cloud computing node 10 includes a computer system/server (or more generally a data processing system) 12, which is operational with numerous other general purpose or special purpose computing system environments or configurations. Examples of well-known computing systems, environments, and/or configurations that may be suitable for use with computer system/server 12 include, but are not limited to, personal computer (PC) systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 (in cloud computing node 10) is illustrated in the form of a general-purpose computing device. The components of computer system/server 12 may include, but are not limited to, one or more processors or processing units (including one or more processor cores) 16, a system memory 28, and a bus 18 that couples various system components (including system memory 28) to processors 16. Bus 18 represents one or more of any of several types of bus structures, including a memory bus or memory controller bus, a peripheral bus, an accelerated graphics port, and a processor or local bus using any of a variety of bus architectures. By way of example, and not limitation, such architectures include the industry standard architecture (ISA) bus, the micro channel architecture (MCA) bus, the enhanced ISA (EISA) bus, the video electronics standards association (VESA) local bus, and the peripheral components interconnect (PCI) bus.

Computer system/server 12 typically includes a variety of computer system readable media. Such media may be any available media that is accessible by computer system/server 12, and includes both volatile and non-volatile media, removable and non-removable media. System memory 28 can include computer system readable media in the form of volatile memory, such as random access memory (RAM) 30 and/or cache memory 32.

Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, nonvolatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces.

As will be further depicted and described herein, memory 28 may include at least one program product having a set (e.g., at least one) of program modules that are configured to carry out the functions of various disclosed embodiments. Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, one or more other devices that enable a user to interact with computer system/server 12, and/or any devices (e.g., network card, modem, etc.) that enable computer system/server 12 to communicate with one or more other computing devices. Such communication can occur via input/output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components can be used in conjunction with computer system/server 12. Examples, include, but are not limited to: microcode, device drivers, redundant processing units, external disk drive arrays, redundant array of inexpensive disk (RAID) systems, tape drives, and data archival storage systems, etc.

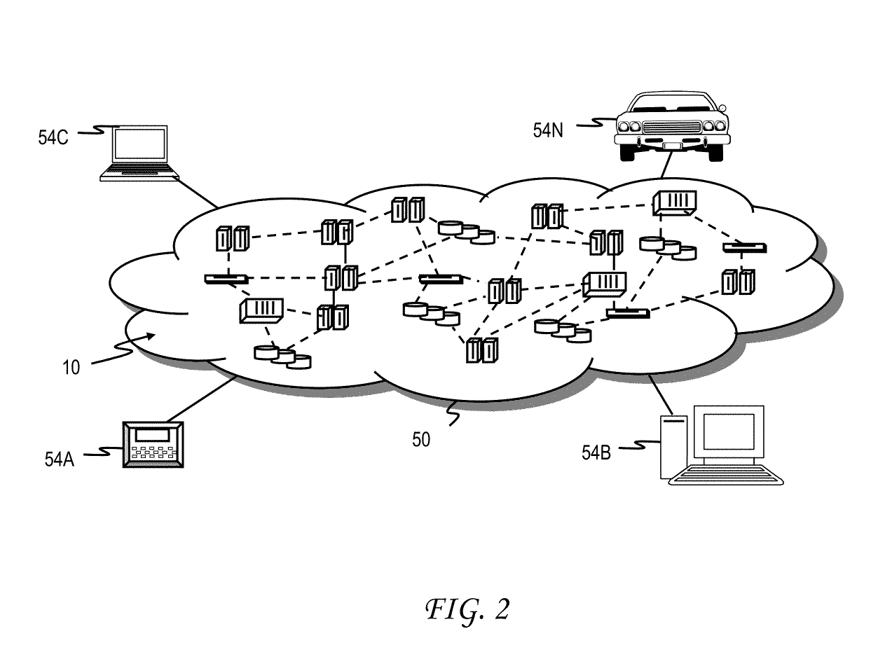

With reference to FIG. 2, an illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone MA, desktop computer MB, laptop computer MC, and/or automobile computer system MN, may communicate. Nodes 10 may communicate with one another and may be grouped (not shown) physically or virtually, in one or more networks, such as private, community, public, or hybrid clouds as described herein, or a combination thereof. In this manner, cloud computing environment 50 can offer infrastructure, platforms and/or software as services for which a cloud consumer does not need to maintain resources on a local computing device. It should be understood that the types of computing devices MA-N shown in FIG. 2 are intended to be illustrative only and that computing nodes 10 and cloud computing environment 50 can communicate with any type of computerized device over any type of network and/or network addressable connection (e.g., using a web browser).

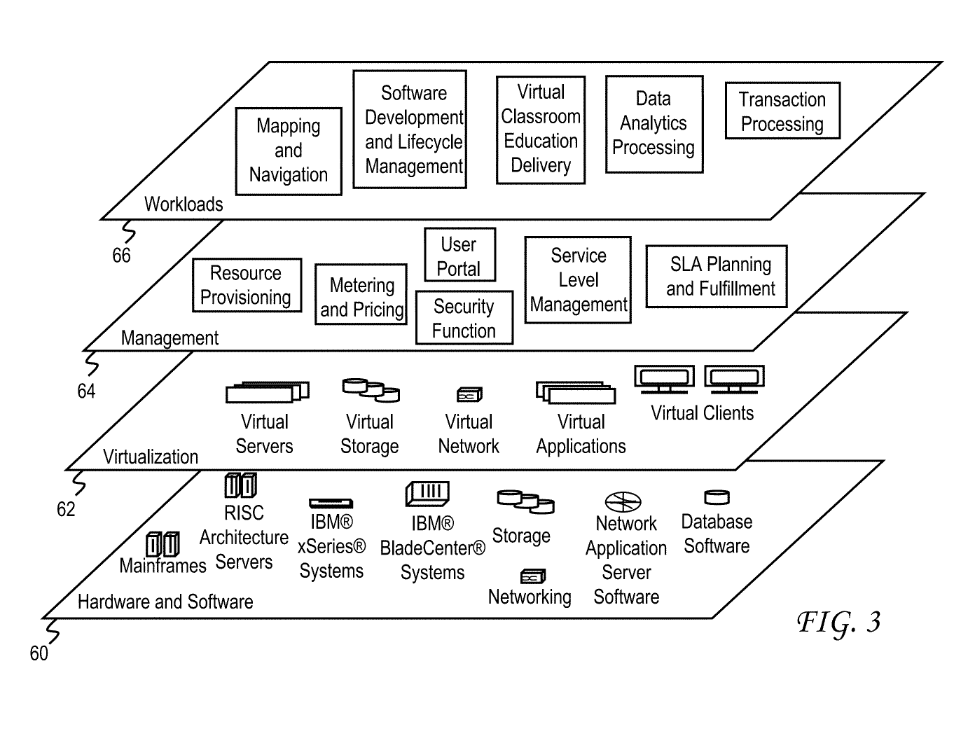

With reference to FIG. 3, a set of functional abstraction layers provided by cloud computing environment 50 (FIG. 2) is shown. It should be understood that the components, layers, and functions shown in FIG. 3 are intended to be illustrative only and embodiments of the invention are not limited thereto. As depicted in FIG. 3, cloud computing environment 50 includes a hardware and software layer 60, a virtualization layer 62, a management layer 64, and a workloads layer 66.

Hardware and software layer 60 includes various hardware and software components. As one example, the hardware components may include mainframes (e.g., IBM® zSeries® systems), reduced instruction set computer (RISC) architecture based servers (e.g., IBM® pSeries® systems), IBM® xSeries® systems, IBM® BladeCenter® systems, storage devices, networks and networking components. As another example, the software components may include network application server software (e.g., IBM® WebSphere® application server software) and database software (e.g., IBM® DB2® database software). IBM, zSeries, pSeries, xSeries, BladeCenter, WebSphere, and DB2 are trademarks of International Business Machines Corporation registered in many jurisdictions worldwide.

Virtualization layer 62 provides an abstraction layer in which virtual entities (e.g., virtual servers, virtual storage, virtual networks (including virtual private networks), virtual applications and operating systems, and virtual clients are included. As previously discussed, these virtual entities may be accessed by clients of cloud computing environment 50 on-demand. The virtual entities are controlled by one or more virtual machine monitors (VMMs) that may, for example, be implemented in hardware and software layer 60, virtualization layer 62, or management layer 64.

Management layer 64 provides various functions (e.g., resource provisioning, metering and pricing, security, user portal, service level management, and SLA planning and fulfillment). The resource provisioning function provides dynamic procurement of computing resources and other resources that are utilized to perform tasks within the cloud computing environment. For example, the resource provisioning function may be performed for virtual machines (VMs) by one or more VMMs. The metering and pricing function provides cost tracking (as resources are utilized within the cloud computing environment) and billing or invoicing for consumption of the utilized resources. As one example, the utilized resources may include application software licenses.

The security function provides identity verification for cloud consumers and tasks, as well as protection for data and other resources. The user portal function provides access to the cloud computing environment for consumers and system administrators. The service level management function provides cloud computing resource allocation and management such that required service levels are met. For example, the security function or service level management function may be configured to limit deployment/migration of a virtual machine (VM) image to geographical location indicated to be acceptable to a cloud consumer. The service level agreement (SLA) planning and fulfillment function provides pre-arrangement for, and procurement of, cloud computing resources for which a future requirement is anticipated in accordance with an SLA.

Workloads layer 66 provides examples of functionality for which the cloud computing environment may be utilized. Examples of workloads and functions which may be provided from this layer include: mapping and navigation; software development and lifecycle management; virtual classroom education delivery; data analytics processing; and transaction processing.

Available conventional tools for constructing virtual images (VIs) have been designed for single image construction. Single image construction does not readily lend itself to automating the construction of application VIs for virtual system patterns that have interdependencies. As is known, virtual system patterns provide topology definitions that are used for repeatable deployment. Conventionally, all products (or applications) with interdependencies have been provided in a single VI (which is not generally desirable for production environments) or a VI for each product (application) has been manually constructed one at a time to reflect the interdependencies. As used herein, an interdependency is indicated when one product (application) depends on another product (application). As one example, a system manager product (e.g., TBSM) may depend on a DB2 database server product, in that the system manager product accesses the DB2 database server product to store/retrieve system information.

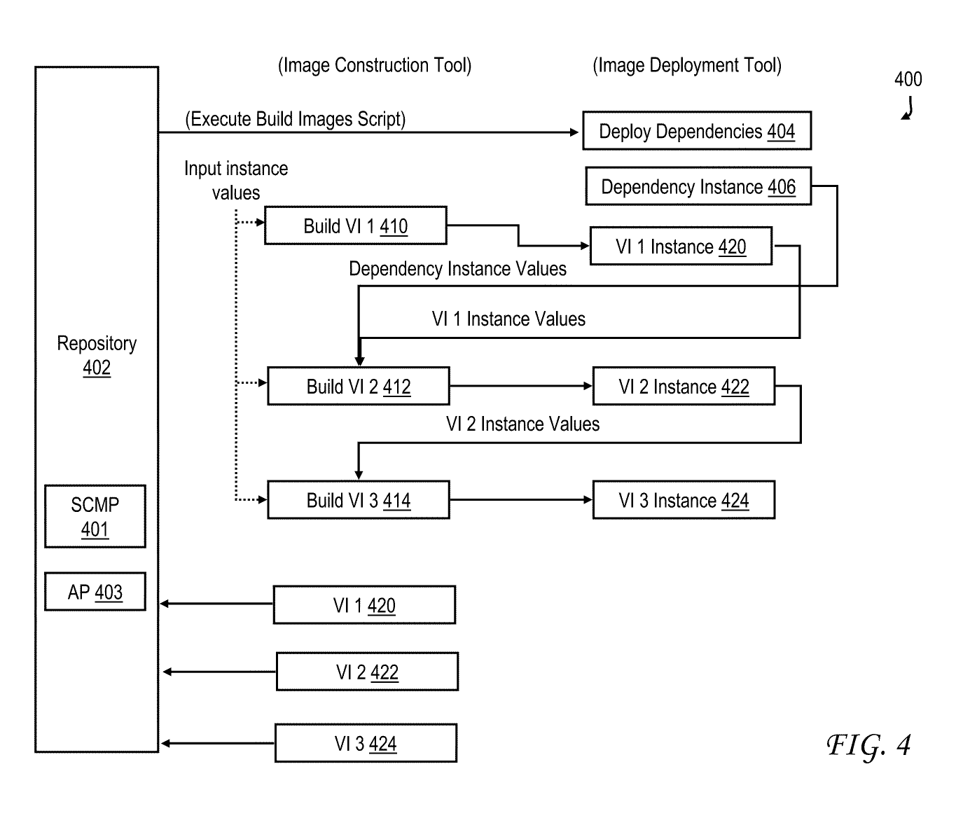

With reference to FIG. 4, a system 400 is illustrated that is configured to automate the construction of multiple VIs that have interdependencies, according to an embodiment of the present disclosure. A source control management product (SCMP), e.g., TBSM, 401 is configured to execute an automation process (AP) 403 (e.g., an RTC tool) that initiates a build image creation process by an image construction tool (e.g., an ICON tool). SCMP 401 also deploys product (application) dependencies 404 of desired products (applications) in an image deployment tool (e.g., SCO). Automation process (AP) 403 creates dependency instance values 406 (e.g., port names, host names, and repository names) that interdependent product VIs utilize.

When the VI building process is initiated, a first base VI (labeled “VI 1”) 410 is extended with input instance values (e.g., host name, port name, repository name, user names, and user passwords, etc. associated with base VI 410), and software bundles (e.g., applications that are utilized in first base VI 410) are added to first base VI 410 to create a first VI instance 420. Instance values (e.g., host names, port names, and repository names) from first VI instance (labeled “VI 1 instance”) 420 and dependency instance values (e.g., host names, port names, and repository names of interdependent VIs) from deployed dependency instance 406 are passed to a second base VI 412 (labeled “VI 2”). Second base VI 412 is extended (using associated input instance values, the instance values from first VI instance 420, and dependency instance values from deployed dependency instance 406) and software bundles (which install and configure second base VI 412) are added to create a second VI instance (labeled “VI 2 instance”) 422. Instance values from second VI instance 422 are then passed to a third base VI (labeled “VI 3) 414. Third base VI 414 is extended (using associated input instance values and the instance values from second VI instance 422), and software bundles (which install and configure third base VI 414) are added to create a third VI instance (labeled “VI 3 instance”) 424.

Subsequent VI instances (not shown) may be created in a similar manner as third VI instance 424. For example, a fourth base VI may be extended (using the instance values from third VI instance 424) and software bundles (which install and configure the fourth base VI) may be added to create a fourth VI instance. In various embodiments, following the creation of a last VI instance, the VI instances are synchronized (i.e., deployed to designated VMs in a cloud) for testing and development. Upon completion of the last VI instance, the automation process 403 may then store each of the VI instances in a repository 402 and clean-up (delete) any VI instances instantiated by the image deployment tool during the process.

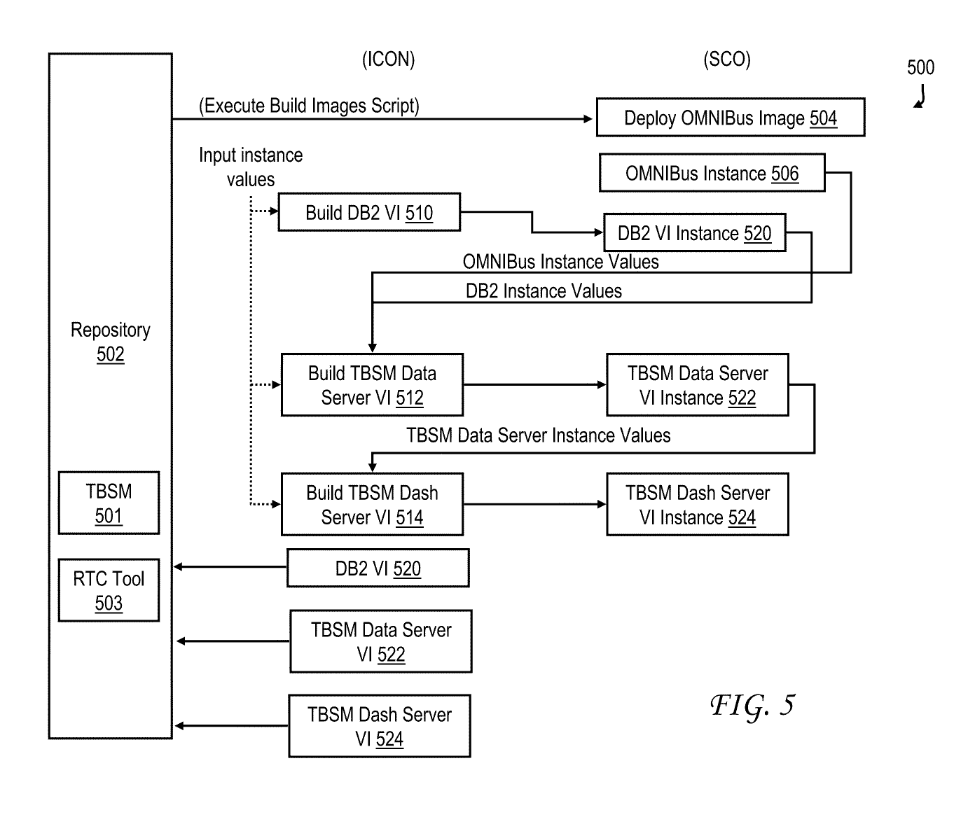

In FIG. 5, a system 500 is illustrated that implements a multi-product image building process with TBSM 501 using an RTC tool 503 to deploy an OMNIbus image 504 and an OMNIbus instance 506 in SCO. OMNIbus instance 506 includes dependency instances for interdependent target applications. As is illustrated, a DB2 VI 510, a TBSM data server VI 512, and a TBSM dashboard server VI 514 are created in ICON. DB2 VI 510 is extended using input instances (e.g., host name, port name, repository name, user names, and user passwords) and associated applications are added to create a DB2 VI instance 520. TBSM data server VI 512 is extended using OMNIBus instance values (e.g., host names, port names, and repository names) passed from OMNIBUS instance 506, DB2 instance values (e.g., host name, port name, and repository name) passed from DB2 instance 520, and associated input instance values (e.g., user names and user passwords) and associated applications are added to create a TBSM data server VI instance 522. TBSM dash server VI 514 is extended using TBSM data server instance values (e.g., host names, port names, and repository names) passed from TBSM data server VI instance 522 and associated input instance values (e.g., user names and user passwords) and associated applications are added to create a TBSM data server VI instance 522. DB2 VI instance 520, TBSM data server VI instance 522, and TBSM dash server VI instance 524 may then be stored in a repository 502 for use in, for example, test and development.

Exemplary code that provides a Python implementation with Netcool/OMNIbus in IBM Workload Deployment (IWD)/SCO is illustrated below:

“““Fully functional script to extend a base image from ICON, install OMNIbus core component at synchronization time and capture the new image. This python script verifies that the new image does not already exist in the function ‘checkMyImage’. The python script verifies the base image specified to extend does exist in ‘checkBaseImage’. The python script then adds the software bundles and runs extend/sync in ‘extendSync’. If everything goes right, the python script captures the new image.”””

from icct.prettify import prettify
import time
startClock = time.clock( )

##############################################
# Define some common functions for single or multi-server installation
##############################################
def checkMyImage(myNewImage)

print ‘\nCheck for pre-existing image...’
print myNewImage
images = cloudprovider.getImages( )
found = False
count=0
while (count<len(images)):

image = images[count]
if (myNewImage[‘name’] == image.name and myNewImage[‘version’] == image.version):

print ‘\n New image name : %s already exists’ % (image.name)
found = True
break

count += 1

if (found == True):

print ‘Cannot continue with image creation since the image already exists’ print ‘Please

increment the image version number and try again’

exit(−1)

def checkBaseImage(myBaseImage):
##########################################
# Locate the base image
###########################################

#Search the IWD cloud provider for our base image

if (myImageState == “notStarted”):
print ‘\nLocate the base image...’
images = cloudprovider.getImages( )
found = False
count=0
while (count<len(images)):

image = images[count]

#print ‘\n Image is: %s’ % (image)

if (myBaseImage[‘name’] == image.name and myBaseImage[‘version’] == image.version):

print ‘\n Base image name : %s was found’ % (image.name)
found = True

break

count += 1

if (found == False):
print ‘Base image %s was not found’ % (myBaseImage[‘name’])
print ‘\n\n There are %d images’ % (len(images))
print ‘\n\n The images available are: %s’ % images
exit(−1)

print ‘\n Base image is: %s’ % (image)
return image

def extendSync(myNewImage,myBundles,myBaseImage):
#############################################
# Extend the base image
#############################################
#Save base image reference for later

baseImage = image
# build up image extend parameters
parms = { }
parms[‘name’] = myNewImage[‘name’]
parms[‘symbolicName’] = myNewImage[‘uuid’]
parms[‘description’] = myNewImage[‘desc’]
parms[‘version’] = myNewImage[‘version’]
print ‘\nExtending the base image...’
print ‘...parms %s\n’ % (prettify(parms))
newImage = image.extend(parms)
newImage.waitFor( )
#print ‘\nExtended image is %s’ % (newImage)
#newImage
print “\nReplace the personality tags...”
# Modify the part/personlity name
# - Look for the old part name and replace with ours; they must be different
if (myNewImage[‘personality_key’] != myBaseImage[‘personality_key’]):

newImage.modifyPersonality(myBaseImage[‘personality_key’],{‘description’:myNewImage[‘p

ersonality_desc’],‘key’: myNewImage[‘personality_key’],‘label’: myNewImage[‘personality_label’]})

print “\nAdding Bundles...”
bcount = 0
while (bcount<len(myBundles)):

myBundle = myBundles[bcount]
print ‘\n Locate bundle: %s, version: %s’ % (myBundle[‘name’], myBundle[‘version’])
bundles = icct.bundles
found = False
count=0
while (count<len(bundles)):

bundle = bundles [count]
if (myBundle[‘name’] == bundle.name and myBundle[‘version’] == bundle.version):

print ‘ Bundle %s was found’ % (myBundle[‘name’])
found = True
break

count += 1

if (found == False):

print ‘\nBundle %s was not found’ % myBundle[‘name’]
print ‘\n\n There are %d bundles’ % (len(bundles))
print ‘\n\n The bundles available are: %s’ % bundles
newImage.delete( )
exit(3)

#print ‘\n Our selected bundle is: %s’ % (bundle)
#print ‘\n Adding bundle %s to the image’ % (bundle.name)
print “ ....parms are %s” % (myBundle[‘installParms’])
newImage.addBundle(bundle.id, myBundle[‘installParms’])
bcount += 1
syncParamsForImage = newImage.getSynchronizeParametersForImage( )
print ‘\n\n Synchronize parameters for the image are: \n%s’ % prettify(syncParamsForImage)
for aParam in syncParamsForImage:

if aParam[‘name’] == ‘password’:

print ‘\n\n Setting the password’
aParam[‘value’]=‘tbsm01bm’

#print ‘\n\n Setting the ROOT password for the image’
#NOTE: This assumes only one image parameter!
#syncParamsForImage[0][‘args’][0][‘value’]= myNewImage[‘root_password’]
syncParamsForCloud = newImage.getSynchronizeParametersForCloudProvider( )
print ‘\n\n Synchronize parameters for the cloud provider before: \n%s’ %

prettify(syncParamsForCloud)

print “\n >>> for arg in syncParamsForCloud:print arg[‘name’]”
for arg in syncParamsForCloud:

print arg[‘name’]

# Locate the profile in the valid choices and determine which choice to return

cloudGroups = syncParamsForCloud[0][‘validValues’]
cloudGroupLabel = myCloudProvider[‘cloud_group’]
cloudGroupValue = None
for cloudGroup in cloudGroups:

print ‘\nCloud Label = %s’ % cloudGroup[‘label’]
if cloudGroup[‘label’].find(cloudGroupLabel) != −1:

cloudGroupValue=cloudGroup[‘value’]
print ‘\nCloud Group label %s was found’ % cloudGroupLabel

#Iterate thru the key/value pairs and set the values for the base image root userid/pw
for arg in syncParamsForCloud:

print ‘\nArg Name = %s’ % arg[‘name’]
if arg[‘name’] == ‘envprofile’:

print ‘\n\n envprofile set’
arg[‘value’]=‘0’

if arg[‘name’] == ‘ipgroup’:

| print ‘\n\n retrieve ipgroup value’ | |
|---|---|
| ipgroupValidValues = arg[‘validValues’] | print ‘\n\n ipgroup ValidValues is |

| | |
|---|---|
| %s’ %ipgroup ValidValues | ipgroupValue = ipgroup ValidValues[0][‘value’] |

| | |
|---|---|
| print ‘\n\n ipgroupValue is %s’ %ipgroupValue | arg[‘value’]=ipgroupValue |

if arg[‘name’] == ‘cloudgroup’:

print ‘\n\n Cloudgroup set’
arg[‘value’]=cloudGroup Value

if arg[‘name’] == ‘username’:

print ‘\n\n username set’
arg[‘value’]=myBaseImage[‘sync_user’]

if arg[‘name’] == ‘password’:

| | |
|---|---|
| print ‘\n\n ROOT password set’ | arg[‘value’]=myBaseImage[‘sync_password’] |

print ‘\n\n Synchronize parameters for the cloud provider after: \n%s’ %

prettify(syncParamsForClo ud)

print ‘\n\nSynchronize the image...’
print ‘\n Time now is ...’, time.ctime( ) newImage.synchronize(syncParamsForImage,

syncParamsForCloud, True)
print ‘ Wait for synchronize to complete...’
newImage.waitFor( )
if newImage.currentImageState != ‘synced’:

print ‘\n\aSync Failed!!!’
exit(1)

print ‘ Time now is ...’, time.ctime( )
myImageState = “synced”
#print ‘\n Delete the base image to save space’
#baseImage.delete( )

return newImage

def capImage(newImage):
##########################################
# Capture the image
###########################################

print ‘\nCapture the image...’
newImage.capture( )
print ‘ Wait for capture to complete...’
newImage.waitFor( )
if newImage.currentImageState != ‘completed’:

print ‘\n\aCapture Failed!!!’
exit(1)

print ‘ Time now is ...’, time.ctime( )
captureClock = time.clock( )
myImageState = “captured”

#####################################
# End of functions
#####################################
myCloudProvider = {

‘name’ : ‘Tivoli CIT IWD 3.1.0.7’,
‘type’ : ‘iwd’,
‘cloud_group’ : ‘siteIT’,

}
print “\nLocate a cloud provider instance”
cloudproviders = icct.cloudproviders
count=0
found = False
while (count<len(cloudproviders)):

cloudprovider = cloudproviders[count]
#print ‘\n Cloudprovider name is: %s, type is %s’ % (cloudprovider.name,

cloudprovider.cloudProviderType)

if myCloudProvider[‘name’] == cloudprovider.name:

#print ‘\n Cloud provider id: %s was found’ % (cloudprovider.id)
cloudproviderId = cloudprovider.id
found = True
break

count += 1

if (found == False):

print “\n Cloud provider %s was not found!” % (myCloudProvider[‘name’]) print ‘\n\n There

are %d cloud providers’ % (len(cloudproviders))

print ‘\n\n The list of cloud providers available are %s:’ % (cloudproviders)
exit(−1)

print “\nCloud Provider details:”
print cloudprovider
#####################################
# Will use the same base image for both systems #####################################
myImageState = “notStarted”
BaseImage = {

‘name’ : ‘Test_CIT_RHEL62_64_30G’,
‘version’: ‘1.0.2’,
‘uuid’ : ‘com.ibm.iwd.test_coc_rhel62_64_30GB’,
‘personality_key’ : ‘OS Part’,
‘sync_user’ : ‘root’,
‘sync_password’ : ‘tbsm01bm’

}
image = checkBaseImage(BaseImage)
print image
#####################################
# Start the extend of the OMNIbus core
#####################################
myNew1Image = {

‘name’ : ‘TivCIT_OMNIbus’,
‘uuid’ : ‘cit.omnibus.core’,
‘desc’ : ‘OMNIbus V7.4 Core image with EIF,SNMP,Knowledge library, ITME Event Sync, and

ITCAMfTT RT event int egration’,

‘version’: ‘1.0.5’,
‘personality_key’ : ‘TivCIT_OMNIbus’,
‘personality_label’ : ‘TivCIT_OMNIbus’,
‘personality_desc’ : ‘OMNIbus V7.4’,

}
checkMyImage(myNew1Image)
myCoreBundleInstallParms1 = [
]
myCoreBundle = {

‘name’ : ‘OMNIbus V7.4Core’,
‘version’ : ‘1.0.1’,
‘reposFilename’ : ‘cit.omnibus.v7.4’,
‘installParms’ : myCoreBundleInstallParms1,

}
myBundles = [

myCoreBundle

]
print “Starting extend and sync of OMNIbus Core\n”
omniImage = extendSync(myNew1Image,myBundles,BaseImage)
myIP = omniImage.getVirtualSystemIPAddress( )
print ‘My OMNIbus Core IP is\n%s’ % prettify(myIP)
coreIP = myIP.encode(‘ascii’,‘ignore’)
#####################################
# Start the extend of the OMNIbus WebGUI
#####################################
myNew2Image = {

‘name’ : ‘OMNIbus V7.4 WebGUI’,
‘uuid’ : ‘cit.omnibus.7.4’,
‘desc’ : ‘OMNIbus V7.4 WebGUI’,
‘version’: ‘1.7.4’,
‘personality_key’ : ‘TivCIT_OMNIbusWebGUI’,
‘personality_label’ : ‘TivCIT_OMNIbusWebGUI’,
‘personality_desc’ : ‘OMNIbus V7.4’,

}
checkMyImage(myNew2Image)
myWebBundleInstallParm1 = {

‘name’: ‘o’,
‘type’: ‘string’,
‘value’: coreIP,

}
myWebBundleInstallParm2 = {

‘name’: ‘u’,
‘type’: ‘string’,
‘value’: ‘username@us.ibm.com’,

}
myWebBundleInstallParms = [

myWebBundleInstallParm1,
myWebBundleInstallParm2,

]
myWebBundle = {

‘name’ : ‘OMNIbus WebGUI’,
‘version’ : ‘1.0.1’,
‘reposFilename’ : ‘cit.omni.webui’,
‘installParms’ : myWebBundleInstallParms,

}
myBundles = [

myWebBundle

]
print “Starting extend and sync of WebGUI\n”
webImage = extendSync(myNew2Image,myBundles,BaseImage)
#####################################
# Start the capture of the images
#####################################
print “Capturing the OMMNIbus core image\n”
capImage(omniImage)
print “Capturing the OMMNIbus WebGUI image\n”
capImage(webImage)
endClock = time.clock( )
overallTime = endClock − startClock
print “\nOverall =”, overallTime, “ seconds or ”, overallTime/60, “ minutes”
print ‘\a\a\a\a\n Done!’
exit(0)

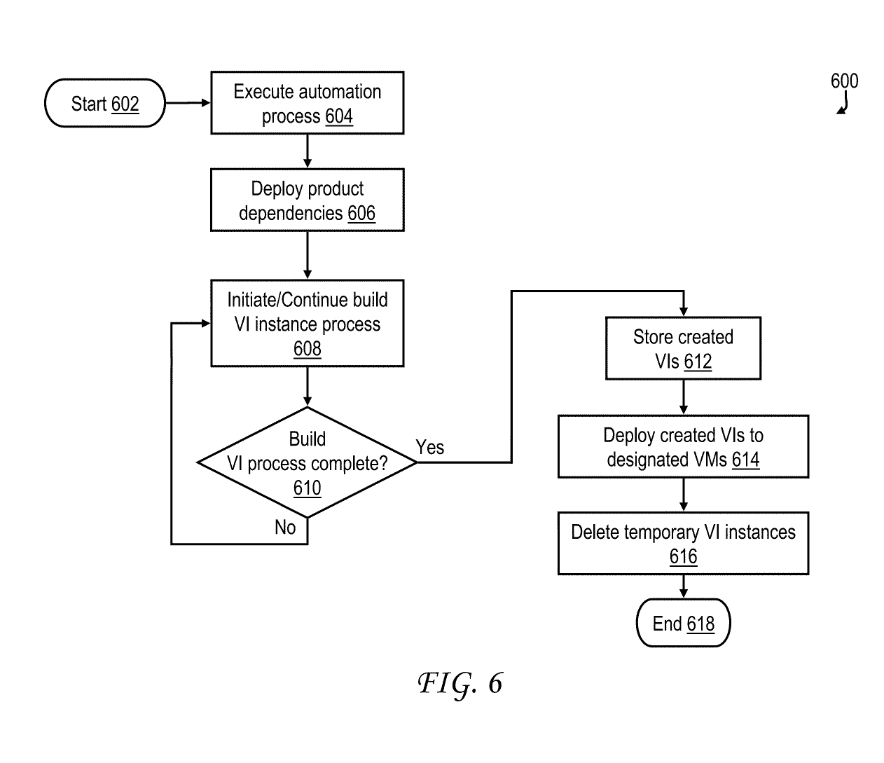

With reference to FIG. 6 a process 600 for automating the construction of multiple VIs that have interdependencies, according to one aspect of the present disclosure, is illustrated. Process 600 may be implemented, for example, through the execution of one or more program modules 42 (see FIG. 1) of cloud control software residing in management layer 64 (see FIG. 3) by processor 16 (of computer system 12).

Process 600 may, for example, be initiated in block 602 in response to receipt of a user request to create VIs with interdependencies. Next, in block 604, a SCMP (e.g., TBSM) 401 is configured to execute an automation process (e.g., an RTC tool) 403 that initiates a build image creation process by an image construction tool (e.g., an ICON tool). Then, in block 606, SCMP 401 also deploys product (application) dependencies 404 of desired products (applications) in an image deployment tool (e.g., SCO). In general, automation process (AP) 403 creates dependency instance values 406 (e.g., port names, host names, and repository names) that interdependent product VIs utilize.

Next, in block 608, the VI instance building process is initiated. For example, a first base VI 410 may be extended with input instance values (e.g., a host name, a port name, a repository name, user names, and user passwords, etc. associated with base VI 410) and software bundles (e.g., applications that are utilized in first base VI 410) are added to first base VI 410 to create a first VI instance 420. Instance values (e.g., host names, port names, and repository names) from first VI instance 420 and dependency instance values (e.g., host names, port names, and repository names of interdependent VIs) from deployed dependency instance 406 are passed to a second base VI 412. Second base VI 412 is extended (using associated input instance values, the instance values from first VI instance 420, and dependency instance values from deployed dependency instance 406) and software bundles (which install and configure second base VI 412) are added to create a second VI instance 422.

Next, in decision block 610, processor 16 determines whether the VI instance build process is complete. In response to the VI instance build process not being complete in block 610, control transfers from block 610 to block 608, where the VI instance build process continues. That is, instance values from second VI instance 422 are passed to a third base VI 414. Third base VI 414 is then extended (using associated input instance values and the instance values from second VI instance 422) and software bundles (which install and configure third base VI 414) are added to create a third VI instance 424. Next, in block 610, processor 16 again determines whether VI instance build process is complete. In response to the VI build process not being complete in block 610 control again transfers to block 608, where a subsequent VI instance may be created in a similar manner as third VI instance 424. For example, a fourth base VI may be extended (using the instance values from third VI instance 424) and software bundles (which install and configure the fourth base VI) may be added to create a fourth VI instance.

In response to the VI build process being complete in block 610 control transfers to block 612 where the VI instances (e.g., first VI instance 420, second VI instance 422, and third VI instance 424) are stored in repository 402. Then, in block 614, the created VI instances are deployed to designated VMs for execution. Next, in block 616 the temporary VI instances created in the image deployment tool (e.g., SCO) are deleted. Next, in block 618, process 600 terminates until a next request to create interdependent images is received.

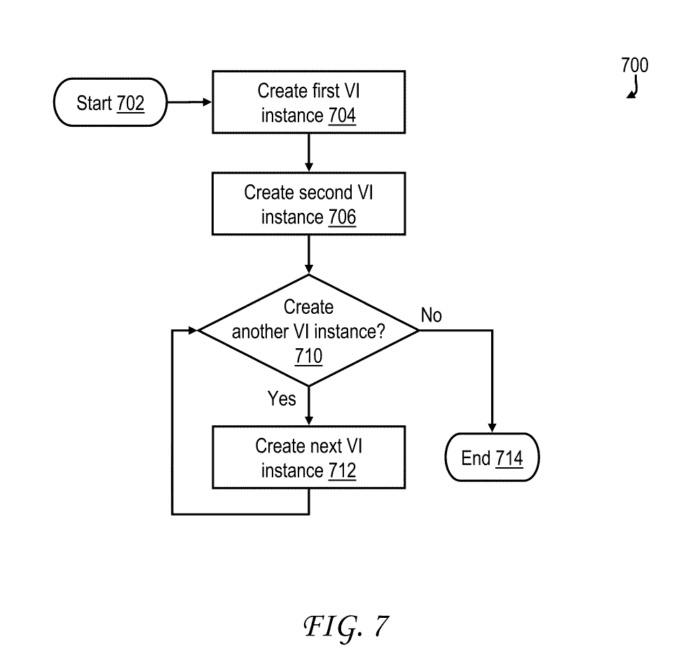

With reference to FIG. 7 a process 700 illustrates blocks 608 and 610 in additional detail, according to one or more embodiments. Process 700 is initiated in block 702 in response to initial entry of process 600 into block 608. In block 708, the VI instance building process is initiated and a first base VI 410 is extended with input instance values (e.g., a host name, a port name, a repository name, user names, and user passwords, etc. associated with base VI 410) and software bundles (e.g., applications that are utilized in first base VI 410) are added to first base VI 410 to create a first VI instance 420. Next, in block 706, instance values (e.g., host names, port names, and repository names) from first VI instance 420 and dependency instance values (e.g., host names, port names, and repository names of interdependent VIs) from deployed dependency instance 406 are passed to a second base VI 412. Second base VI 412 is extended (using associated input instance values, the instance values from first VI instance 420, and dependency instance values from deployed dependency instance 406) and software bundles (which install and configure second base VI 412) are added to create a second VI instance 422.

Next, in decision block 710, processor 16 determines whether another VI instance is required to be created. In response to another VI instance requiring creation in block 710, control transfers to block 712, where a next VI instance is created. That is, instance values from second VI instance 422 are passed to a third base VI 414. Third base VI 414 is then extended (using associated input instance values and the instance values from second VI instance 422) and software bundles (which install and configure third base VI 414) are added to create a third VI instance 424. Next, control returns to block 710, processor 16 again determines whether VI instance build process is complete. In response to the VI build process not being complete in block 710 control again transfers to block 712, where a subsequent VI instance may be created in a similar manner as third VI instance 424. For example, a fourth base VI may be extended (using the instance values from third VI instance 424) and software bundles (which install and configure the fourth base VI) may be added to create a fourth VI instance. In response to the VI instance build process being complete in block 710 control transfers to block 714, where the process 700 terminates.

A fully qualified domain name (FQDN) is the complete domain name for a specific computer or host on the Internet. The FQDN includes two parts: the host name and the domain name. For example, an FQDN for a hypothetical mail server might be ‘mail.college.edu’. In the example, the host name is ‘mail’, and the host is located within the domain ‘college.edu’. In this example, ‘edu’ is the top-level domain (TLD). Within the ‘edu’ TLD, the University of Missouri-Columbia has been assigned the ‘missouri.edu’ domain, and has authority to create sub-domains within the ‘missouri.edu’ domain and web addresses. For example, www.missouri.edu is the FQDN on the web for MIZZOU™. In this case, ‘www’ is the name of the host in the ‘missouri.edu’ domain. When connecting to a host (using, for example, a secure shell (SSH) client), the FQDN must be specified. A domain name system (DNS) server then resolves the host name to an associated IP address by searching a DNS table associated with the DNS server. The host is contacted and a login prompt may be received. When only a host name (without the domain information) is specified when attempting to connect to a server, a utilized application may not be able to resolve the host name (for example, a DNS suffix search order in TCP/IP properties of a computer may be incorrect or a DNS table may be corrupted). In these cases, entering the FQDN of a host will usually allow the DNS to locate the server. Also, if a remote host is not local to an Internet service provider (ISP), a FQDN may be required.

The SSH program provides an encrypted channel for logging into a remote computer over a network, executing commands on the remote computer, and moving files from one computer to another computer. SSH provides relatively strong host-to-host and user authentication, as well as secure encrypted communications over the Internet. SSH2 is a more secure, efficient, and portable version of SSH that implements the secure file transfer protocol (SFTP), which is functionally similar to the file transfer protocol (FTP), but is SSH2 encrypted.

In a highly integrated cloud deployment, a process for identifying and locating different VMs is desirable to facilitate communication between VMs in a cloud deployment. Being able to quickly and accurately identify an IP address or FQDN of other VMs in a cloud deployment is also desirable for quick configuration. According to another embodiment of the present disclosure, techniques are disclosed that facilitate immediate availability of system IP addresses and FQDNs for ease of integration at cloud start-up time. In general, the disclosed techniques allow for reduced footprint in terms of script packages and ordering with maximum benefit. The disclosed techniques may generally be readily adapted to any cloud deployment regardless of technology and provide a robust approach for passing environment information to a list of VMs in an integrated cloud deployment pattern.

In general, the disclosed techniques also reduce the complexity of other script packages in a cloud environment, eliminating in many cases the need for environmental parameter passing. For example, with host file adaptation inter-system communications may be accomplished using short names (i.e., FQDNs without the domain name) for a product. According to one embodiment, a single script package is added to a cloud deployment pattern. In this embodiment, the script package includes cloud deployment variables for each VI that is to be deployed in the cloud deployment pattern. For example, using cloud deployment variables, parameters may be passed to the script package for substitution at deployment time in the cloud. For example, assignments for the VMs DBmachine and Applmachine may take the following form:
DBmachine_FQDN: ${DBmachine.hostname}.${DBmachine.domain}
DBmachine_IP: ${DBmachine.ipaddr}
Appl1machine_FQDN: $ {Appl1machine.hostname}.${Appl1machine.domain}
Appl1machine_IP: ${Appl1machine.ipaddr}
   In the above assignments, the variables on the right of the colon are cloud deployment variables that are passed into a cloud deployment system and the variables on the left of the colon are variables that may be passed to an application.

In general, the assignment process is repeated for each VM in a cloud deployment pattern. The script package is first executed (e.g., by one of the VMs) in the cloud deployment pattern ordering at deployment time and is configured to: set a variable for each VM to a deploy time value and store a name value pair in an assignment file (e.g., pattern.ips.log) in a known directory; push the assignment file to every other IP address in the assignment file (except for the one it is running on) in the cloud deployment pattern; and store the assignment file in a same directory for all VMs. Additionally, the script may add a system IP, FQDN, short name, and product alias to a file (e.g., a file named ‘temphosts’) that defines system information for a VM. The system information file may then be pushed to all other VMs, and a script associated with each of the VMs may be executed to make a copy of a mapping file (e.g., the ‘/etc/hosts’ file, which is a UNIX file that maps between host names and IP addresses) and append the contents of the system information file to the mapping file, except for the current VM entry (e.g., to prevent duplicate entries for the same host). Appending the contents of the ‘temphosts’ file to ‘/etc/hosts’ file facilitates the utilization of SSH between VMs via an alias (e.g., ‘ssh product_alias1’ or ‘ssh product_alias2’).

In various embodiments, scripts running on any VM are only required to access the system information file to directly use the variables included in the system information file to facilitate communication between VMs in the deployment. As one example, on a VM named ‘Appl1machine’ if a database (DB) link is needed after accessing the system information file, using information in the assignment file (e.g., /location/pattern_ips.log) a shell script may access a DB VM IP using $DBmachine_IP. According to the present disclosure, other scripts in a cloud deployment pattern may be simplified as additional parameter passing for system information is not usually required.

An exemplary script that sets variables and pushes the variables to all other VMs in a cloud deployment pattern is set forth below:

An example of the use of one the above variables in an integration script package that runs after the above-described script package may take the following form:

/tmp/configTopo/pattern_ips.log
TEPSfqdn=‘echo $POC_ITM_FQDN‘

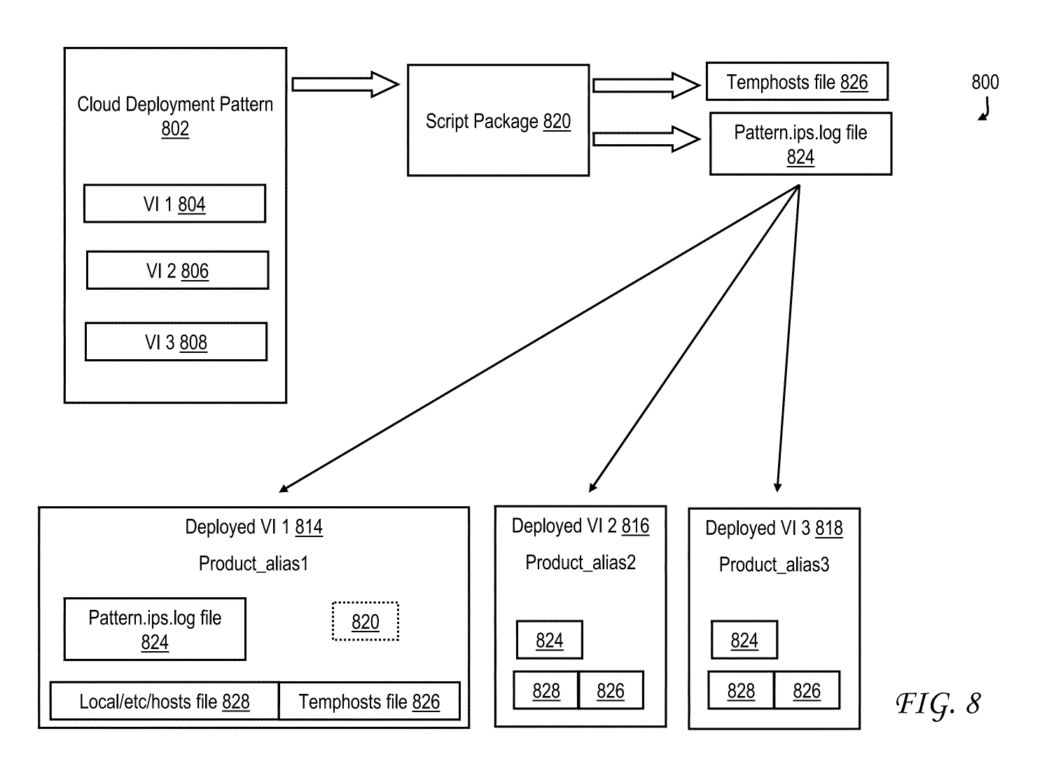

With reference to FIG. 8, a diagram 800 illustrates the creation of the above-described files (i.e., the temphosts file and the pattern.ips.log file) in conjunction with an exemplary deployment of three VIs 804, 806, and 808 that are included a cloud deployment pattern 802 to, for example, different VMs. Script package 820 may be executed by a VM associated with one of VIs 802, 804, and 806 at deployment time. Script package 820 is configured to: set a variable for each of VIs 802, 804, and 806 to a deploy time value and store a name value pair in an assignment file (e.g., pattern.ips.log) 824 in a predetermined directory; push assignment file 824 to every other IP address set (i.e., all other VMs except for the VM the script package is running on) in cloud deployment pattern 802; and store assignment file 824 in a same directory for all VIs 802, 804, and 806. For example, if script package 824 executes on a VM associated with VI 804, assignment file 824 is pushed to respective VMs associated with VIs 804 and 806.

Script package 820 may also add an IP, FQDN, short name, and product alias for each VM to a system information file (e.g., a file named ‘temphosts’) 826 that defines system information for VIs 802, 804, and 806. System information file 826 may then be pushed to all VMs (associated with VIs 802, 804, and 806) and a script (not shown) associated with each of VIs 802, 804, and 806 may be executed to make a copy of a mapping file 828. For example, mapping file 828 may correspond to the ‘/etc/hosts’ file, which is a UNIX file that maps between host names and IP addresses. Contents of assignment file 826 may then be appended to mapping file 828, except for a current VI entry (to prevent duplicate entries for the same host). Appending the contents of the ‘temphosts’ file to ‘/etc/hosts’ file facilitates the utilization of SSH between VMs via an alias (e.g., ‘ssh product_alias1’ or ‘ssh product_alias2’). As is illustrated, deployed VI 1 814 corresponds to VI 1 804 prior to deployment, deployed VI 2 816 corresponds to VI 2 806 prior to deployment, and deployed VI 3 818 corresponds to VI 3 808 prior to deployment. As mentioned above, each VI (e.g., VI 1 814, VI 2 816, and VI 3 818) in a cloud deployment pattern (e.g., cloud deployment pattern 802) includes assignment (e.g., pattern.ips.log) file 824 and a system information (temphosts) file 826 appended to a mapping (e.g., local/etc/hosts) file 828.

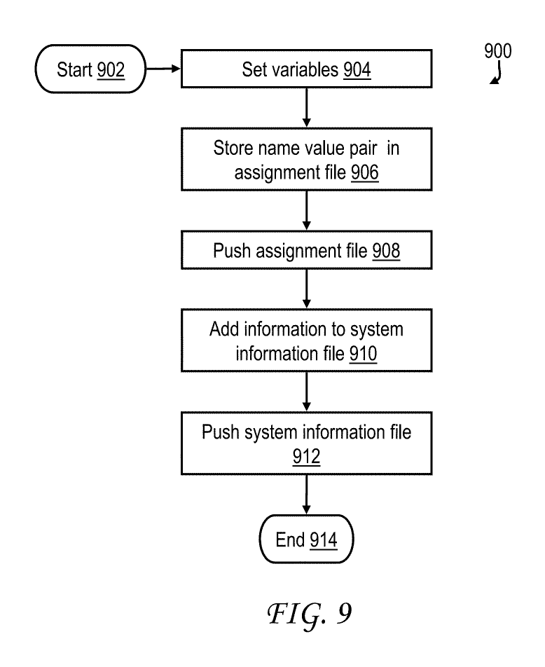

With reference to FIG. 9, a process 900 for integrating virtual images (VIs) in a cloud deployment pattern is illustrated according to an embodiment of the present disclosure. Process 900 may be implemented, for example, through the execution of one or more program modules 42 (see FIG. 1) of cloud control software residing in management layer 64 (see FIG. 3) by processor 16 (of computer system 12).

Process 900 may, for example, be initiated in block 902 in response to a request to deploy VIs to VMs in a cloud environment. Next, in block 904, processor 16 sets a variable for each of the VIs in the cloud deployment pattern to a deploy time value to create a name value pair (e.g., DBmachine_FQDN:${DBmachine.hostname}.${DBmachine.domain}). Next, in block 906, processor 16 causes the name value pair to be stored in an assignment file (e.g., pattern.ips.log) 824. Then, in block 908, processor 16 causes assignment file 824 to be pushed to VMs in the cloud deployment pattern. In one or more embodiments, the variable setting, the storing name value pairs, and assignment file 824 pushing are initiated by script package 820 that is executed by one of the VMs. In at least one embodiment, assignment file 824 is only pushed to the VMs that do not execute the script package. In one embodiment, processor 16 causes assignment file 824 to be stored in a same directory in all of the VMs.

Next, in block 910, processor 16 adds an IP, FQDN, short name, and product alias for each of the VIs to a system information file (e.g., ‘temphosts’) 826. Then, in block 912, processor 16 pushes system information file 826 to the VMs. Each of the VMs may be further configured to append contents of the system information file to a mapping file 828 to facilitate communication between the VMs via an alias using secure shell (SSH). Following block 912, control transfers to block 914 where process 900 terminates until VIs in another cloud deployment pattern require deployment.

Accordingly, techniques have been disclosed herein that advantageously construct virtual images (VIs) for interdependent applications and integrate VIs in a cloud deployment pattern.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the invention has been described with reference to exemplary embodiments, it will be understood by those skilled in the art that various changes may be made and equivalents may be substituted for elements thereof without departing from the scope of the invention. In addition, many modifications may be made to adapt a particular system, device or component thereof to the teachings of the invention without departing from the essential scope thereof. Therefore, it is intended that the invention not be limited to the particular embodiments disclosed for carrying out this invention, but that the invention will include all embodiments falling within the scope of the appended claims. Moreover, the use of the terms first, second, etc. do not denote any order or importance, but rather the terms first, second, etc. are used to distinguish one element from another.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below, if any, are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiments with various modifications as are suited to the particular use contemplated.

1-8. (canceled)

9. A computer program product for automating the construction of multiple virtual images with interdependencies, the computer program product comprising:
a computer-readable storage device having computer-readable program code embodied thereon, wherein the computer-readable program code, when executed by a data processing system, causes the data processing system to:
create a first virtual image (VI) instance by extending a first base VI based on input values associated with the first base VI and software bundles associated with the first base VI;
create a second VI instance by extending a second base VI based on input values associated with the second base VI, instance values received from the first VI instance, dependency instance values received from a deployed dependency instance, and software bundles associated with the second base VI; and
deploy the first and second VI instances to designated virtual machines in a cloud environment for execution.

10. The computer program product of claim 9, wherein the computer-readable program code, when executed by the data processing system, further causes the data processing system to:
create a third VI instance by extending a third base VI based on input values associated with the third base VI, instance values received from the second VI instance, and software bundles associated with the third base VI.

11. The computer program product of claim 10, wherein the computer-readable program code, when executed by the data processing system, further causes the data processing system to:
create a fourth VI instance by extending a fourth base VI based on input values associated with a fourth base VI, instance values received from the third VI instance, and software bundles associated with the fourth base VI.

12. The computer program product of claim 9, wherein the computer-readable program code, when executed by the data processing system, further causes the data processing system to:
in response to completing creation of the second VI instance, store the first and second VI instances in a repository.

13. The computer program product of claim 9, wherein the computer-readable program code, when executed by the data processing system, further causes the data processing system to:
in response to deploying the first and second VI instances, delete locally stored copies of the first and second VI instances.

14. The computer program product of claim 9, wherein a source control management product executes an automation process that initiates a build image creation process to create the first and second VI instances.

15. The computer program product of claim 14, wherein the source management control product also deploys the dependency instance values of target products in a deployment tool.

16-20. (canceled)

21. A data processing system, comprising:
a memory; and
a processor coupled to the memory, wherein the processor is configured to:
create a first virtual image (VI) instance by extending a first base VI based on input values associated with the first base VI and software bundles associated with the first base VI;
create a second VI instance by extending a second base VI based on input values associated with the second base VI, instance values received from the first VI instance, dependency instance values received from a deployed dependency instance, and software bundles associated with the second base VI; and
deploy the first and second VI instances to designated virtual machines in a cloud environment for execution.
